(19) United States
(12) Patent Application Publication
(10) Pub. No.: US 2024/0113917 A1
(43) Pub. Date: Apr. 4, 2024

(54) RECURRENT EQUIVARIANT INFERENCE MACHINES FOR CHANNEL ESTIMATION

(71) Applicant: QUALCOMM Incorporated, San Diego, CA (US)

(72) Inventors: Kumar Pratik, Amsterdam (NL); Arash Behboodi, Amsterdam (NL); Pouriya Sadeghi, San Diego, CA (US); Tharun Adithya Srikrishnan, La Jolla, CA (US); Alexandre Pierrot, San Diego, CA (US); Joseph Binamira Soriaga, San Diego, CA (US); Supratik Bhattacharjee, San Diego, CA (US)

(21) Appl. No.: 17/952,203

(22) Filed: Sep. 23, 2022

(51) Int. Cl. H04L 25/02; H04L 5/00

(52) U.S. Cl. CPC H04L 25/0224; H04L 5/0051

(57) ABSTRACT

Methods, systems, and devices for wireless communications are described. A wireless device may receive an assignment of a set of resources associated with a channel where the set of resources includes a first subset of resources allocated for data transmission and a second subset of resources allocated for a reference signal. The wireless device may generate multiple channel estimations per layer of the channel and perform a refinement operation utilizing the estimations to generate a channel estimation associated with multiple layers. Each iteration of the refinement operation may include generating respective gradients associated with each per layer channel estimation; generating a current set of values of a latent variable; and modifying the channel estimations.

### FIELD OF TECHNOLOGY

The following relates to wireless communications, including recurrent equivariant inference machines for channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support recurrent equivariant inference machines for channel estimation. For example, the described techniques provide for calculating channel estimations using recurrent equivariant inference machines. In some cases, a wireless communications system may place pilot symbols (e.g., demodulation reference signal (DMRS) symbols) in transmission slots according to a known pattern, thus allowing wireless devices to estimate the unknown resources of the channel based on the known resources (e.g., DMRS symbols). For example, a wireless device may receive an assignment of a set of resources associated with a channel where the set of resources includes a first subset of resources allocated for data transmission and a second subset of resources allocated for a reference signal (e.g., DMRS). The wireless device may generate multiple channel estimations per layer of the channel (e.g., single-input and single-output (SISO) channel estimations) and perform a refinement operation utilizing the estimations to generate a channel estimation associated with multiple layers (e.g., a multiple-input and multiple-output (MIMO) channel estimation). In some cases, the refinement operation may include multiple iterations. For example, each iteration may include generating respective gradients associated with each per layer channel estimation based on the per layer channel estimations and observed resources of the channel (e.g., the known DMRS resources); generating a current set of values of a latent variable (e.g., an inferred variable based on observed variables) based on a previous set of values of the latent variable, the respective gradients, and the per layer channel estimations; and modifying (e.g., refining, updating, improving) the channel estimations based on the current set of values of the latent variable, the per layer channel estimations, and the respective gradients. In some cases, the refinement operation may be performed by a refinement network that includes a likelihood module, an encoder module, and a decoder module.

A method for wireless communication is described. The method may include receiving an assignment of a set of resources associated with a channel including a first subset of resources allocated for a data signal and a second subset of resources allocated for a reference signal, generating a set of multiple channel estimations associated with respective layers of a set of multiple layers of the channel for the set of resources, and performing a refinement operation on the set of multiple channel estimations including one or more iterations, where each iteration of the one or more iterations may include operations, features, means, or instructions for generating respective gradients associated with the set of multiple channel estimations based on the set of multiple channel estimations for the second subset of resources and measured observations of the second subset of resources, generating, based on a first set of values of a latent variable, the set of multiple channel estimations, and the respective gradients, a second set of values of the latent variable, and modifying the set of multiple channel estimations associated with the set of multiple layers based on the second set of values of the latent variable, the set of multiple channel estimations, and the respective gradients.

An apparatus for wireless communication is described. The apparatus may include a processor, memory coupled with the processor, and instructions stored in the memory. The instructions may be executable by the processor to cause the apparatus to receive an assignment of a set of resources associated with a channel including a first subset of resources allocated for a data signal and a second subset of resources allocated for a reference signal, generate a set of multiple channel estimations associated with respective layers of a set of multiple layers of the channel for the set of resources, and perform a refinement operation on the set of multiple channel estimations including one or more iterations, where the instructions to each iteration of the one or more iterations are executable by the processor to cause the apparatus to generate respective gradients associated with the set of multiple channel estimations based on the set of multiple channel estimations for the second subset of resources and measured observations of the second subset of resources, generate, based on a first set of values of a latent variable, the set of multiple channel estimations, and the respective gradients, a second set of values of the latent variable, and modify the set of multiple channel estimations associated with the set of multiple layers based on the second set of values of the latent variable, the set of multiple channel estimations, and the respective gradients.

Another apparatus for wireless communication is described. The apparatus may include means for receiving an assignment of a set of resources associated with a channel including a first subset of resources allocated for a data signal and a second subset of resources allocated for a reference signal, means for generating a set of multiple channel estimations associated with respective layers of a set of multiple layers of the channel for the set of resources, and means for performing a refinement operation on the set of multiple channel estimations including one or more iterations, where the means for each iteration of the one or more iterations include means for generating respective gradients associated with the set of multiple channel estimations based on the set of multiple channel estimations for the second subset of resources and measured observations of the second subset of resources, means for generating, based on a first set of values of a latent variable, the set of multiple channel estimations, and the respective gradients, a second set of values of the latent variable, and means for modifying the set of multiple channel estimations associated with the set of multiple layers based on the second set of values of the latent variable, the set of multiple channel estimations, and the respective gradients.

A non-transitory computer-readable medium storing code for wireless communication is described. The code may include instructions executable by a processor to receive an assignment of a set of resources associated with a channel including a first subset of resources allocated for a data signal and a second subset of resources allocated for a reference signal, generate a set of multiple channel estimations associated with respective layers of a set of multiple layers of the channel for the set of resources, and perform a refinement operation on the set of multiple channel estimations including one or more iterations, where the instructions to each iteration of the one or more iterations are executable to generate respective gradients associated with the set of multiple channel estimations based on the set of multiple channel estimations for the second subset of resources and measured observations of the second subset of resources, generate, based on a first set of values of a latent variable, the set of multiple channel estimations, and the respective gradients, a second set of values of the latent variable, and modify the set of multiple channel estimations associated with the set of multiple layers based on the second set of values of the latent variable, the set of multiple channel estimations, and the respective gradients.

In some examples of the method, apparatuses, and non-transitory computer-readable medium described herein, generating the respective gradients may include operations, features, means, or instructions for generating respective sets of values of a residual variable based on a difference between the measured observations of the second subset of resources and the set of multiple channel estimations for the second subset of resources and combining the respective sets of values of the residual variable, the measured observations of the second subset of resources, and a quantity of mask bits.

In some examples of the method, apparatuses, and non-transitory computer-readable medium described herein, generating the second set of values of the latent variable may include operations, features, means, or instructions for combining the set of multiple channel estimations for the second subset of resources, the respective gradients, and respective values of the first set of values of the latent variable based on generating the respective gradients.

In some examples of the method, apparatuses, and non-transitory computer-readable medium described herein, generating the second set of values of the latent variable may include operations, features, means, or instructions for modeling correlation between resources of each resource block of a group of resource blocks and other resource blocks of the group of resource blocks.

In some examples of the method, apparatuses, and non-transitory computer-readable medium described herein, generating the second set of values of the latent variable may include operations, features, means, or instructions for modeling correlation between resources of each group of a set of multiple groups of resources of the set of resources and other groups of the set of multiple groups of resources, where each group of the set of multiple groups of resources includes a set of multiple resource blocks.

In some examples of the method, apparatuses, and non-transitory computer-readable medium described herein, generating the second set of values of the latent variable may include operations, features, means, or instructions for modeling correlation between each layer of the set of multiple layers for the set of resources.

In some examples of the method, apparatuses, and non-transitory computer-readable medium described herein, modifying the set of multiple channel estimations may include operations, features, means, or instructions for combining the second set of values of the latent variable, the set of multiple channel estimations, and the respective gradients.

In some examples of the method, apparatuses, and non-transitory computer-readable medium described herein, initial values of the set of multiple channel estimations may be associated with SISO antenna pairs.

In some examples of the method, apparatuses, and non-transitory computer-readable medium described herein, the second subset of resources may be configured according to a resource configuration pattern of a set of resource configuration patterns.

In some examples of the method, apparatuses, and non-transitory computer-readable medium described herein, the set of resource configuration patterns may be a set of DMRS patterns.

In some examples of the method, apparatuses, and non-transitory computer-readable medium described herein, each iteration may be performed by a refinement network including a likelihood module, an encoder module, and a decoder module, and each refinement network further includes a respective parameter associated with a machine learning operation.

In some examples of the method, apparatuses, and non-transitory computer-readable medium described herein, the set of resources includes one or more groups of resources, and each respective layer of the set of multiple layers may be associated with a respective antenna pair of a set of multiple SISO antenna pairs.

### BRIEF DESCRIPTION OF THE DRAWINGS

FIG. 1 illustrates an example of a wireless communications system that supports recurrent equivariant inference machines for channel estimation in accordance with one or more aspects of the present disclosure.

FIGS. 2-5 illustrate examples of networks that support recurrent equivariant inference machines for channel estimation in accordance with one or more aspects of the present disclosure.

FIGS. 6 and 7 show block diagrams of devices that support recurrent equivariant inference machines for channel estimation in accordance with one or more aspects of the present disclosure.

FIG. 8 shows a block diagram of a communications manager that supports recurrent equivariant inference machines for channel estimation in accordance with one or more aspects of the present disclosure.

FIG. 9 shows a diagram of a system including a device that supports recurrent equivariant inference machines for channel estimation in accordance with one or more aspects of the present disclosure.

FIGS. 10 and 11 show flowcharts illustrating methods that support recurrent equivariant inference machines for channel estimation in accordance with one or more aspects of the present disclosure.

### DETAILED DESCRIPTION

Some wireless communications systems may support channel estimations. For example, a wireless device may estimate resources of a channel to maintain high data throughput. To accomplish channel estimation, some communication systems may utilize a tracking reference signal (TRS) to calculate channel characteristics (e.g., doppler, delay spread, signal-to-noise (SNR), and the like) and estimate the channel resources based on the channel characteristics. However, TRS may include a relatively large overhead (e.g., memory, computation) and not all wireless communication systems may continuously transmit TRS, which may result in inaccurate channel estimations. Additionally, some wireless communications systems may support multiple-input and multiple-output (MIMO) communication in which multiple resource layers may interfere with each other, further reducing the accuracy of the channel estimations. To reduce the overhead and inconsistency of TRS, as well as accounting for the cross-MIMO interferences, the channel estimation procedure may be updated.

The techniques described herein provide for calculating channel estimations using recurrent equivariant inference machines. In some cases, a wireless communications system may place pilot symbols (e.g., demodulation reference signal (DMRS) symbols) in transmission slots according to a known pattern, thus allowing wireless devices to estimate the unknown resources of the channel based on the known resources (e.g., DMRS symbols). For example, a wireless device may receive an assignment of a set of resources associated with a channel where the set of resources includes a first subset of resources allocated for data transmission and a second subset of resources allocated for a reference signal (e.g., DMRS). The wireless device may generate multiple channel estimations per layer of the channel (e.g., single-input and single-output (SISO) channel estimations) and perform a refinement operation utilizing the estimations to generate a channel estimation associated with multiple layers (e.g., a MIMO channel estimation). In some cases, the refinement operation may include multiple iterations. For example, each iteration may include generating respective gradients associated with each per layer channel estimation based on the per layer channel estimations and observed resources of the channel (e.g., the known DMRS resources); generating a current set of values of a latent variable (e.g., an inferred variable based on observed variables) based on a previous set of values of the latent variable, the respective gradients, and the per layer channel estimations; and modifying (e.g., refining, updating, improving) the channel estimations based on the current set of values of the latent variable, the per layer channel estimations, and the respective gradients. In some cases, the refinement operation may be performed by a refinement network that includes a likelihood module, an encoder module, and a decoder module.

Aspects of the disclosure are initially described in the context of wireless communications systems. Aspects of the disclosure are then described in the context of networks. Aspects of the disclosure are further illustrated by and described with reference to apparatus diagrams, system diagrams, and flowcharts that relate to recurrent equivariant inference machines for channel estimation.

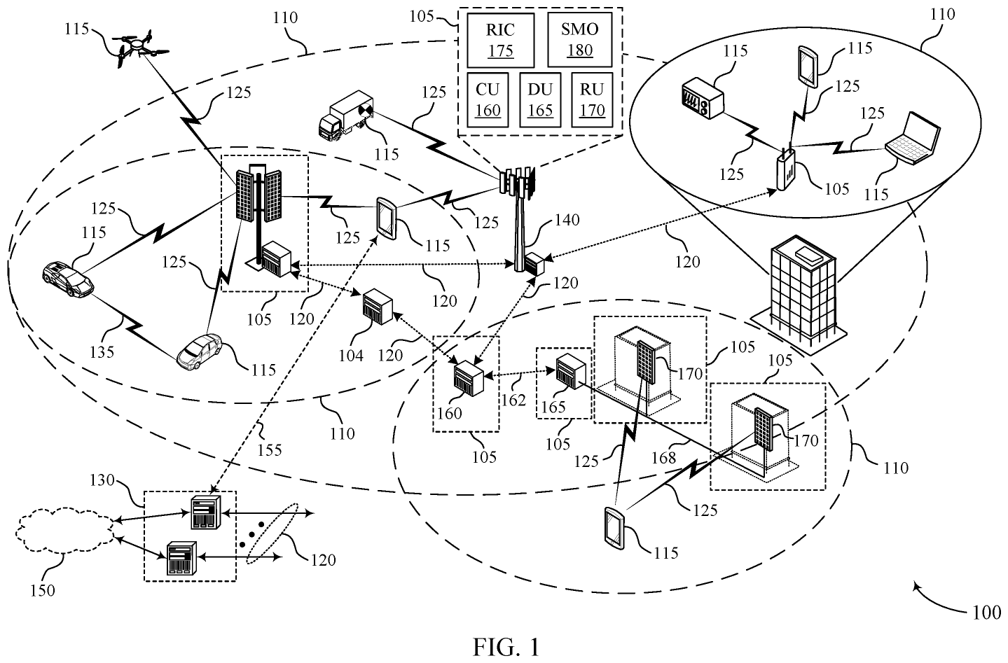

FIG. 1 illustrates an example of a wireless communications system 100 that supports recurrent equivariant inference machines for channel estimation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support recurrent equivariant inference machines for channel estimation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, the wireless communications system 100 may support SISO communication, MIMO communication, or both. For example, SISO communication may include a communication between a single transmitter and a single receiver, whereas MIMO communication may include a communication between multiple transmitters and multiple receivers. In some cases, MIMO communications may include multiple SISO communications via a transmitter and receiver pair (e.g., a transmitting antenna and a receiving antenna pair). For example, a network entity 105 may include a first and a second transmitting antenna and a UE 115 may include a first and a second receiving antenna. The antenna pairs may include the first transmitting with the first receiving antennas, the first transmitting with the second receiving antennas, the second transmitting with the first receiving antennas and the second transmitting with the second receiving antennas. Each antenna pair may modify a signal utilizing a beamforming matrix (e.g., a precoding matrix, an orthogonal matrix) prior to transmission of the signal to minimize interference (e.g., linear precoders, beamformers, may create beams that focus energy for each receive antenna by weighting the phase and magnitude of transmission antennas). Because the beamforming matrix may be unknown to the receiver (e.g., the UE 115, the network entity 105), the receiver may estimate the pre-coded channel.

In some examples, the wireless communications system 100 may support channel estimations. For example, the channel estimation may be for resource grid based (e.g., slot based) wireless MIMO-OFDM systems. The channel estimation may be a 5G NR channel estimation with varying DMRS patterns, quantity of resource blocks, and the like. The channel estimation may be for super-resolution or signal recovery based on sparse observations.

In MIMO communication, multiple layers of information (e.g., communication) may interfere with each other, making the channel estimations more complex. In some cases, orthogonal cover codes may be used to remove the interference with a de-spreading step. De-spreading steps, however, may be inadequate for frequency selective or fast fading channels (e.g., high delay spread and high Doppler response). Additionally, narrowband MIMO communication (e.g., communication using relatively small chunks of bandwidth parts) may utilize different precoding matrices for each group of resources (e.g., physical resource groups (PRGs)) that may be unknown to a UE 115. The unknown precoding matrices may add a higher complexity to channel estimation, such that some wireless communications systems may not use correlation between non-contiguous PRGs in the channel estimation. For example, some estimation techniques (e.g., minimum mean square error (MMSE)) may utilize TRS, or another continuous reference signal, to calculate channel characteristics (e.g., Doppler, delay spread, signal-to-noise (SNR), and the like) and estimate the channel resources based on the channel characteristics.

In some cases, some estimation techniques may include least square and linear MMSE (LMMSE). Least square may not use information about channel statistics or noise variance and may not model correlations across different PRGs and MIMO layers, thus making it relatively simple to implement with low computational expenses. However, the estimation accuracy may be inadequate for most use cases (e.g., practical applications). LMMSE may utilize second-order channel statistics and noise variance (e.g., binning based strategies based on estimated channel parameters, such as Doppler, delay spread, and the like). LMMSE may have a high computational expense and have a relatively low estimation error under some conditions. However, LMMSE may not model correlations across different PRGs and MIMO layers.

In some cases, some estimation techniques may include deep learning based techniques. The deep learning based techniques may not utilize explicit information of channel statistics and may utilize non-linear interpolation. Unlike LMMSE, the deep learning techniques may not utilize big matrix inversion operations. The deep learning technique may utilize a separate network for every DMRS pattern. In some cases, the deep learning techniques may not consider correlation across different PRGs.

The techniques described herein provide for calculating channel estimations using recurrent equivariant inference machines, which may result in a channel estimation based on DMRS symbols that utilizes the correlation between non-contiguous PRGs (e.g., without a knowledge of precoders). In some cases, a wireless communications system 100 (e.g., OFDM systems) may deploy pilot-based channel estimation techniques for obtaining CSI with relative accuracy (e.g., obtaining accurate CSI may help maintain high data throughput, for example, in a fast fading environment). The pilot symbols may be referred to as DMRS symbols. The DMRS symbols may be inserted in transmission slots according to a known DMRS pattern, thus allowing wireless devices to estimate the unknown resources (e.g., non-DMRS locations, resources allocated for a data signal) of the channel based on the known resources (e.g., DMRS symbols). In some cases, the DMRS patterns may be pre-configured (e.g., a fixed set of possible DMRS patterns). A DMRS pattern may be used based on the channel characteristics.

In some examples, a wireless device may receive an assignment of a set of resources associated with a channel where the set of resources includes a first subset of resources allocated for data transmission (e.g., non-DMRS) and a second subset of resources allocated for a reference signal (e.g., DMRS). The wireless device may generate multiple channel estimations per layer of the channel (e.g., SISO channel estimations) and perform a refinement operation utilizing the estimations to generate a channel estimation associated with multiple layers (e.g., a MIMO channel estimation). In some cases, the refinement operation may include multiple iterations. For example, each iteration may include generating respective gradients associated with each per layer channel estimation based on the per layer channel estimations and observed resources of the channel (e.g., the known DMRS resources); generating a current set of values of a latent variable (e.g., an inferred variable based on observed variables) based on a previous set of values of the latent variable, the respective gradients, and the per layer channel estimations; and modifying (e.g., refining, updating, improving) the channel estimations based on the current set of values of the latent variable, the per layer channel estimations, and the respective gradients. In some cases, the refinement operation may be performed by a refinement network that includes a likelihood module, an encoder module, and a decoder module.

In some cases, the wireless communications system 100 may incorporate end-to-end (E2E) use of neural networks for channel state feedback. Such a neural network structure may be used for channel state information feedback (CSF) by providing intermediate channel representation to the wireless communications network and a wireless device (e.g., a receiving wireless device, a network entity 105) may reconstruct the channel (e.g., split implementation of the proposed method at the UE and the network side), such that this type of model architecture may have specification to some degree of interoperability.

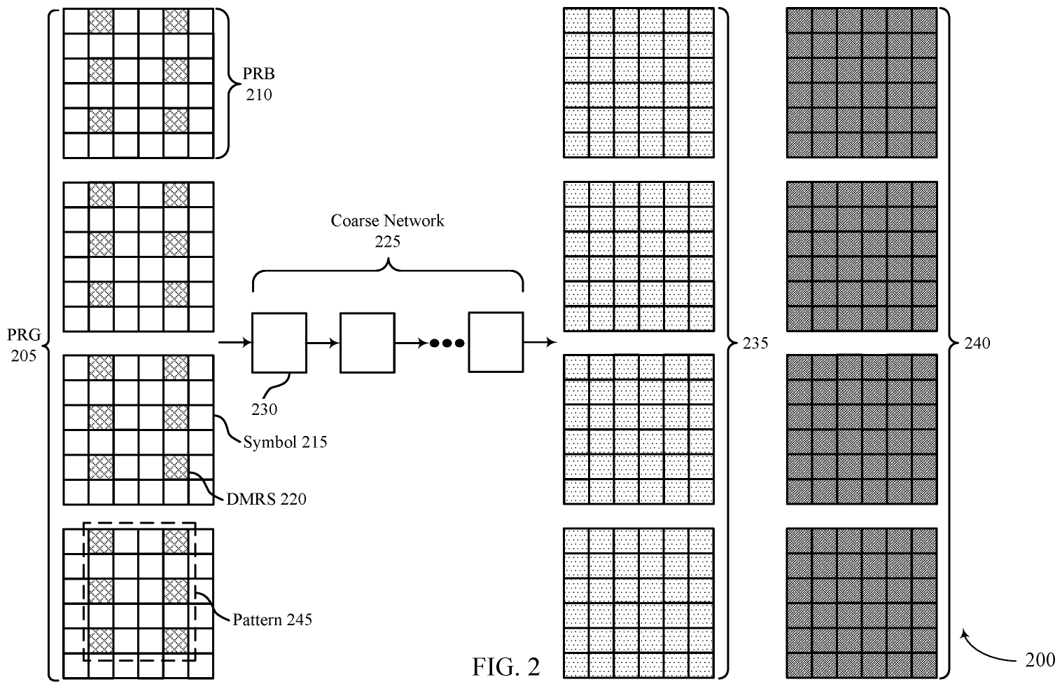

FIG. 2 illustrates an example of a network 200 that supports recurrent equivariant inference machines for channel estimation in accordance with one or more aspects of the present disclosure. In some examples, the network 200 may be implemented by aspects of the wireless communications system 100. For example, the network 200 may be implemented by a UE 115, a network entity 105, or both, as described herein with reference to FIG. 1.

In some examples, a wireless device (e.g., a UE 115, a network entity 105) may transmit a signal via one or more slots (e.g., a frequency and time grid) using multiple resources (e.g., time resources, frequency resources, and the like). A resource element (e.g., symbol 215, DMRS 220, a single subcarrier for a single OFDM symbol) may be grouped with multiple resource elements to form a physical resource block (PRB) (e.g., PRB 210). Each column of resources (e.g., resource elements of a same time resource and different frequency resources) of the PRB 210 may be considered a single resource block (e.g., an OFDM symbol). In some cases, the PRB 210 may include twelve subcarrier frequencies (of the frequency domain) and fourteen OFDM symbols (of the time domain). Multiple PRBs 210 may be bundled (e.g., grouped, combined) to form a single PRG, such as PRG 205. In some cases, the PRG 205 may include a quantity of PRBs 210 determined by a bundle size parameter (e.g., bundleSize, a quantity of consecutive PRBs stacked together in a single PRG). For example, the bundle size parameter may indicate two PRBs 210 or four PRBs 210 (e.g., four consecutive resource blocks) for a narrowband precoding operation or zero PRBs 210 (e.g., no stacked PRBs) for a wideband precoding operation. and form a portion of a bandwidth part.

In some cases, a wireless communications system (e.g., the wireless communications system 100) may utilize pilot-based channel estimation techniques. The pilot symbols may be referred to as DMRS symbols (e.g., a DMRS symbol 220). For example, the wireless device may transmit a signal including one or more PRBs 210 via a physical downlink shared channel (PDSCH) (e.g., a channel for user data). The PRBs 210 may include various symbols 215 (e.g., resource elements allocated for a data signal), various DMRS symbols 220 (e.g., resource elements allocated for a reference signal for demodulation), and, in some cases, empty symbols (e.g., resource elements with no data allocated).

The DMRS symbols 220 may be inserted in various resource elements of a PRB 210 according to a resource configuration pattern (e.g., a DMRS pattern). For example, the wireless device may be configured with various DMRS patterns and select a DMRS pattern 245 for the signal. In some cases, the various DMRS patterns may include DMRS symbols inserted in adjacent resource elements, every other resource element, in a single resource block of a PRB, multiple resource blocks of a PRB, among other potential configurations.

In some examples, the DMRS pattern 245 may be known by the receiving wireless device. For example, the receiving wireless device may receive the signal and determine which of the symbols of the PRG 205 include the various DMRS 220 based on the DMRS pattern 245. In order to extract (e.g., process, determine, decode, estimate) the data at the symbols 215, the receiving wireless device may perform a channel estimation procedure. For example, the received DMRS 220 (e.g., yᵢ) may be equal to a combination between noise (e.g., interference, nᵢ) and a product between the channel (e.g., PDSCH, hᵢ) and the original data (e.g., xᵢ), according to Equation 1.

yᵢ=hᵢ⊙xᵢ+nᵢ Equation 1:

Because the DMRS 220 is a pilot symbol known by both the transmitting wireless device (e.g., a UE 115, a network entity 105) and the receiving wireless device (e.g., a UE 115, a network entity 105), the receiving wireless device may estimate hᵢ (e.g., extract the channel at DMRS locations) based on the known yᵢ and xᵢ (given some noise). The receiving wireless device may then interpolate (e.g., inpaint as for an image) the estimated channel across the various symbols 215 (e.g., the remaining resource elements) to extract (e.g., calculate) the data at the symbols 215. In some cases, nᵢ may include cross-MIMO interference, inter-PRG interference, intra-PRG interference, and the like. Some channel estimation techniques may not account for (e.g., calculate) these types of interference (e.g., noise), which may lead to inaccurate channel estimations and inaccurate data estimations.

In some implementations, the signal may include multiple PRGs 205, where each PRG 205 may be configured (e.g., precoded) according to a unique precoding matrix. For example, the signal may include four PRGs 205, each precoded according to a unique precoding matrix (e.g., found by performing singular value decomposition (SVD) over resource blocks within the PRG 205). In some cases, the effective channel (e.g., H_{eff}^{prg}) for a first PRG 205 may be equal to a product between the channel and a unique precoding matrix for the first PRG 205, according to Equation 2.

H_{eff}^{prg}=H^{prg}v^{prg}≈yᵢ^{prg}(xᵢ^{prg})^{H} Equation 2:

In some cases, the receiving wireless device may not know which precoding matrix is applied to which PRG 205, thus, the unique precoding of channels per PRG 205 may prohibit smooth interpolation of channel between PRGs 205.

In some implementations, MIMO communication may introduce additional complexities to the channel estimation formulas (e.g., SISO channel estimation formulas). For example, at the DMRS tones inference (e.g., extraction) step, the formula may include multiple unknown equations (e.g., multiple equations with multiple unknown variables), which may lead to solving an underdetermined inverse problem. A complexity may include determining the alignment of the channel across different PRG bundles, and then exploiting the correlation across them. Additionally, the multiple layers may add additional multiplexing information (e.g., correlation across receiver and transmitter antenna pairs) that may be utilized to enhance the channel estimation performance.

The techniques described herein provide for calculating channel estimations using recurrent equivariant inference machines. For example, utilizing a single neural network estimator for multiple use cases of channel estimation (e.g., channel profile estimations, various DMRS pattern configurations, SNR, cross-MIMO estimation, inter-PRG estimation, intra-PRG estimation, and the like) that includes a modular and interpretable model design. In some implementations, the channel estimation may include multiple phases (e.g., steps). For example, a first phase may include solving a SISO channel estimation (e.g., for each transmitter and receiver antenna pair). A second phase may include solving a MIMO channel estimation using the SISO channel estimations (e.g., learning the correlations between the antenna pairs). A third phase may include solving MIMO channel estimations within PRG bundles (e.g., intra-PRG, learning correlations between resource elements within each PRG). A fourth phase may include solving MIMO channel estimations across PRG bundles (e.g., inter-PRG, learning correlations between resource elements across PRG). In some cases, the various phases of the channel estimation may be performed iteratively (e.g., include multiple iterations of the various phases). In some cases, one or more of the phases may utilize an SNR estimation (e.g., genie value). Although four phases are described, a channel estimation procedure utilizing the described techniques may include more or less phases, phases including various other steps, phases without one or more of the steps described, or any combination thereof. While the phases are described as four separate phases, they may be considered as one continuous process.

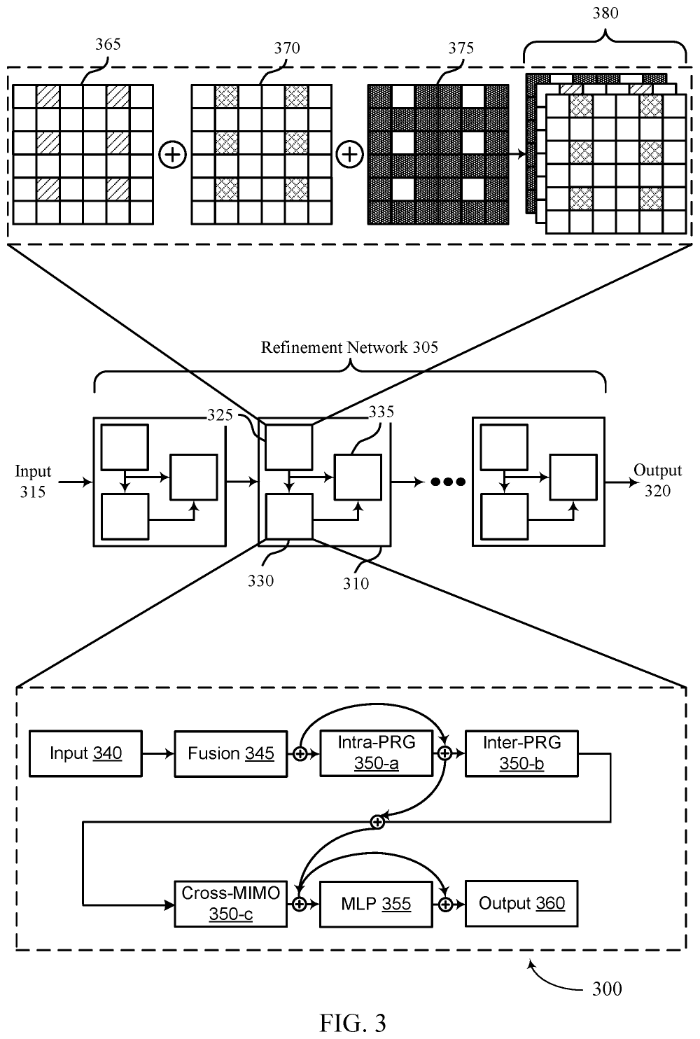

In some cases, a network may perform the various phases. For example, the network may be a request network that includes a coarse network, as described herein with reference to FIG. 2, and a refinement network, as described herein with reference to FIGS. 3-5. In some cases, the network may include a u-net type (e.g., u-net 425) encoder (e.g., encoder 330) and decoder (e.g., decoder 335) convolutional block followed by attention-based (e.g., attention 505) refinement network for longer range correlations. In some examples, the coarse network may provide an initial channel estimate (e.g., a rough estimate) per PRG per antenna pair (e.g., transmission and receiver antenna pair) through a learned interpolation (e.g., smoothing).

The network 200 may represent the first phase. A wireless device (e.g., a UE 115, a network entity 105, or both, as described herein with reference to FIG. 1) may receive an assignment of a set of resources associated with a channel (e.g., a PDSCH channel). The set of resources may include a first subset of resources allocated for a data signal (e.g., symbols 215) and a second subset of resources allocated for a reference signal (e.g., DMRS symbols 220).

In some cases, the wireless device may generate multiple channel estimations 235 associated with respective layers of the channel for the set of resources. For example, the set of resources may include one or more PRGs 205 and the second subset of resources may include various DMRS symbols 220 inserted to respective resource elements based on a resource configuration pattern (e.g., a pattern 245) of a set of resource configuration patterns (e.g., a set of DMRS patterns). Each respective layer may be associated with a respective antenna pair (e.g., a transmitter and receiver pair) of multiple SISO antenna pairs.

In some implementations, initial values of the channel estimations 235 may be associated with SISO antenna pairs. For example, a network 225 (e.g., a coarse network) may involve (e.g., input) the PRG 205 and perform various iterations 230 on the PRG 205. For example, the network 225 may include a u-net encoder decoder fully convolutional network in which each iteration may include gated and gated-dilated convolutional units. In some cases, for one or more iterations 230, the network 225 may copy and concatenate the results of previous iterations 230 to the one or more iterations 230. In some examples, the channel estimations 235 may be channel estimations (e.g., h_{i,j}^{m,k}(f, t), where h is the channel estimation, m is the PRG index, k is the PRB index, i, j is a MIMO index (Tₓⁱ−Rₓ^{j}), and (f, t) is a resource element index inside the PRB two-dimensional grid) for a respective SISO antenna pair per PRG bundle. For example, the wireless device may receive respective PRG bundles per antenna pair. If the MIMO communication includes two transmitting antennas and two receiving antennas, there may be four antenna pairs with multiple PRG bundles for each pair. The wireless device may utilize the network 225 to generate a channel estimation 235 for each antenna pair and each PRG bundle 205. In some cases, the network 225 may output

$${arg max}_{{h}_{i , j}^{m , k}} P [ {h}_{( i , j )}^{m , k} \vert \{ {x}_{dmrs , ( i , j )}^{m . k} , {y}_{dmrs , ( i , j )}^{m , k} : ∀ k \} ] .$$

In some cases, the network 225 may generate a latent variable. For example, the latent variable may be an estimate 240 (e.g., a z estimate) that may not be directly observed, but rather inferred from other observed parameters. The latent variable may be an abstract representation of underlying channel characteristics (e.g., Doppler shift, delay spread). In some examples, the output of the network 225 may be the input (e.g., input 315) of the network 300.

In some cases, the techniques described herein may result in various advantages over the other channel estimation techniques. For example, the channel estimation through the recurrent equivariant inference machines (e.g., networks 200, 300, 400, and 500) may offer various signal processing and deep learning advantages. For example, the signal processing may be based on DMRS (e.g., excluding dependence on TRS, with the exception of SNR), exclude explicit parameter estimation (e.g., Doppler shift, delay spread, and the like), avoid legacy binning strategies, utilize relatively less memory and computational overhead (e.g., reduced maintenance of a bank of parameters), models additional interactions (e.g., interference, cross-MIMO, intra-PRG, inter-PRG processing gain), abstract the OCC despreading step (as described herein with reference to FIG. 1), thus circumventing the associated computational costs and performance loss. The deep learning techniques may include a variable quantity of PRG bundles, a variable quantity of bundle sizes (e.g., PRBs per PRG), multiple DMRS patterns (e.g., multiple input DMRS configurations, quantity of additional columns, configuration type), underlying mathematical symmetries, a forward model into the network design, and a modular and interpretable architecture (e.g., possible to perform ablation study and gauge component significance).

FIG. 3 illustrates an example of a network 300 that supports recurrent equivariant inference machines for channel estimation in accordance with one or more aspects of the present disclosure. In some examples, the network 300 may be an implemented by aspects of the wireless communications system 100. For example, the network 300 may be implemented by a UE 115, a network entity 105, or both, as described herein with reference to FIG. 1.

In some cases, the network 300 may support channel estimation. For example, a channel estimation problem may be defined as maximizing a posterior of the channel (e.g., H) given an observed signal (e.g., y) and the signal (e.g., x) (e.g.,

$${max}_{H , z} [ ln {P}_{z} ( H \vert y , x ) ] ∝ {max}_{H} [ ln {p}_{z} ( y \vert H , x ) + ln {p}_{z} ( H ) ] ) .$$

In some cases, the conditional probability distribution (e.g., P(H|y, x)) may be parametrized by channel characteristics (e.g., delay-doppler profile). The latent variable (e.g., z), as described herein with reference to FIG. 2, may be an abstract representation of the underlying channel characteristics (e.g., Doppler, delay spread, and the like).

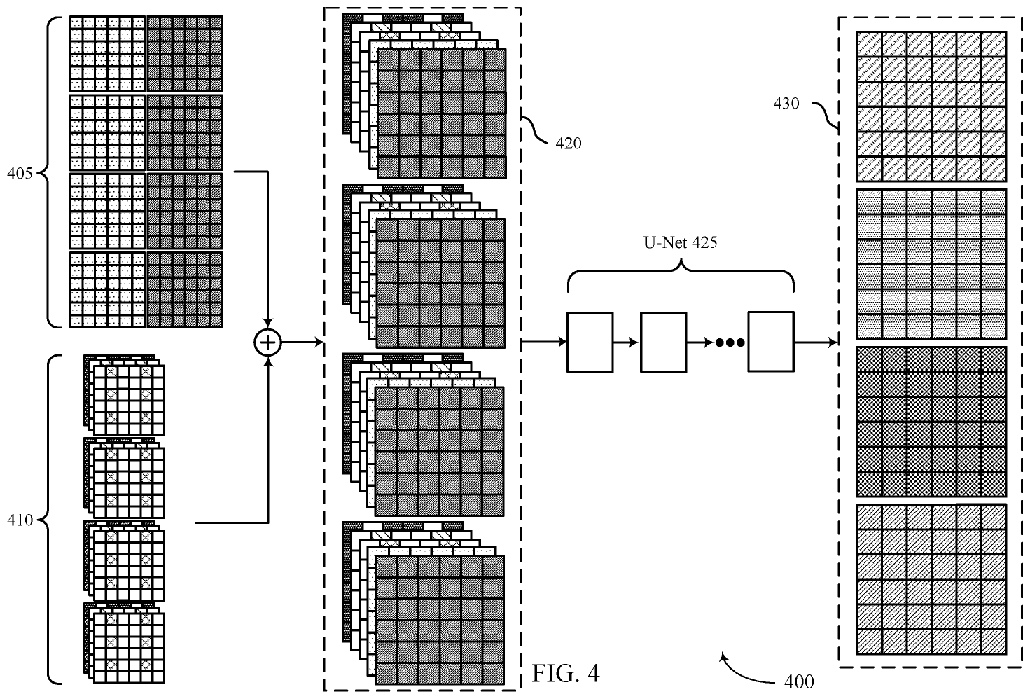

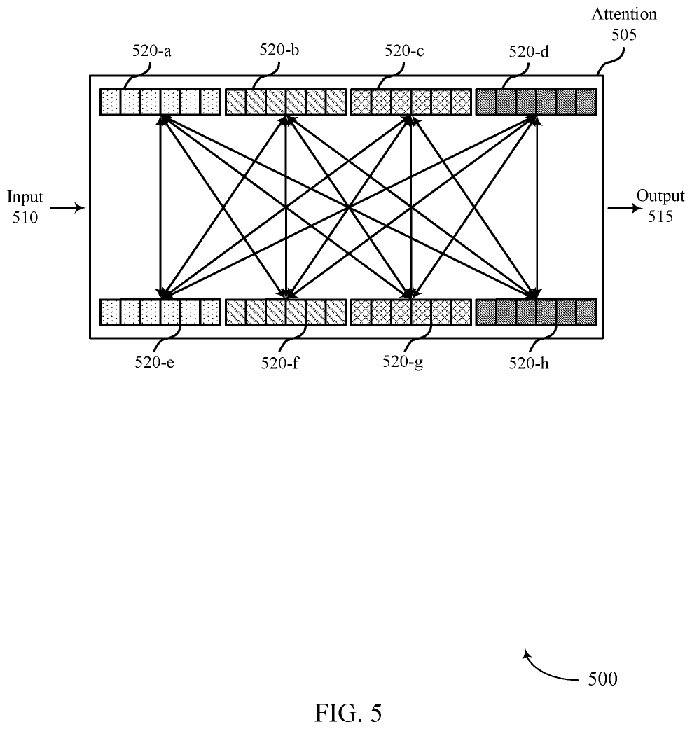

In some cases, an output of the network 200 may be an input of the network 300. For example, an input 315 may include one or more channel estimations (e.g., a channel estimation 235 per PRG 205 per SISO antenna pair) and respective estimates 240 (e.g., respective latent variables per channel estimation). The input 315 may be an input for the refinement network 305 that may include various iterations 310. For example, a wireless device (e.g., a network entity 105, a UE 115) may perform a refinement operation (e.g., via the refinement network 305) on the channel estimations. The refinement operation may include multiple iterations of generating respective gradients (e.g., gradient 380), as described herein with reference to FIG. 3 (e.g., module 325), based on the channel estimations for a subset of resources (e.g., DMRS symbols) and measured observations of the subset of resources (e.g., DMRS symbols 220); generating a second set of latent variables, as described herein with reference to FIGS. 4 and 5 (e.g., module 330), based on the channel estimations and the respective gradients; and modifying the channel estimations associated with multiple layers based on the second set of latent variables, the channel estimations, and the respective gradients, as described herein with reference to FIG. 4 (e.g., module 335).

In some cases, the refinement network 305 may include an iterative refinement by various refinement units. For example, each iteration 310 of the refinement network 305 may be performed by various modules (e.g., three unique refinement modules). For example, an iteration 310 may include a module 325 (e.g., a likelihood module), a module 330 (e.g., an encoder module), and a module 335 (e.g., a decoder module). Additionally, or alternatively, the iteration 310 may include various other modules for performing other tasks not illustrated in FIG. 3. In some examples, the refinement network 305 may include a respective parameter (e.g., a parameter per iteration 310) associated with a machine learning operation. For example, the parameter may be denoted as 0. In some cases, the parameter may be set during a machine learning simulation (e.g., a pre-field operation) and may be unique to each iteration 310, as inputs to each iteration may vary (e.g., different from other, traditional, encoder and decoder machine learning implementations).

In some cases, the module 325 may output to the module 330 and the module 335, the module 330 may output to the module 335, and the module 335 may output to a next iteration 310 or be the final (e.g., last, ultimate) output (e.g., output 320) of the refinement network 305. In some examples, the output of the module 330 (e.g., output 320) may include a channel estimate (e.g., a set of MIMO channel estimations for each of the PRGs, PRBs, and antenna pairs at the respective iteration 310) that is output to a second module 325, a second module 330, and a second module 335 of the next iteration 310. For example, the set of channel estimations (e.g., H^{τ}) for an iteration 310 (e.g., τ) may be equal to {h_{(i,j)}^{m,k,τ}}_{i,j,k,m}. In some cases, the output of the module 330 may include a latent variable (e.g., a set of latent variables for each channel estimate) that is output to the second module 325 and the second module 330 of the next iteration 310. For example, the set of latent variables (e.g., z^{τ}) for an iteration 310 may be equal to {z_{(i,j)}^{m,k,τ}}_{i,j,k,m}.

In some examples, at least a portion of the input 315 may be an input for the module 325. For example, the channel estimations 235, as described herein with reference to FIG. 2, may be input to the module 325. Additionally, or alternatively, the observed DMRS symbols (e.g., y^{dmrs}) and the known DMRS symbols (e.g., x^{dmrs}) may be input to the module 325 (e.g., (y^{dmrs}, x^{dmrs}, σ)). In some cases, the module 325 may coordinate descent on z and H and use recurrent inference as a gradient. For example, the module 325 may generate respective sets of values of a residual variable 365 (e.g., δy_{dmrs,j}^{m,k}) based on a difference between the measured observations of a subset of resources (e.g., DMRS symbols 220) and the channel estimations 235 associated with the subset of resources (H^{τ}x), according to Equation 3. The module 325 may combine the respective sets of values of the residual variable 365, the known observations 370 associated with the subset of resources (e.g., x_{dmrs,i}^{m,k}), and a quantity of mask bits 375 (e.g., a binary mask), according to Equation 3.

$$\frac{\partial ln p ( y \vert {H}^{τ} , x )}{\partial {h}_{( i , j )}^{τ}} = {[ {∇}_{y \vert {H}^{τ} , x} ]}_{i , j} ∝ \frac{{{x}_{i} ( y - {H}^{τ} x )}_{j}^{H}}{{σ}^{2}} ≡ \frac{{x}_{i} * δ {y}_{j}^{H}}{{σ}^{2}} \qquad Equation 3$$

Thus, the module 325 may generate respective gradients 380 (e.g., ∇_{y|H}_{_{,x}}_{^{t}}). For example, each antenna pair may have a respective gradient based on channel components associated with the respective antenna pair. In some cases, as observations are sparse, the feedback from the module 325 (e.g., the feedback module) may also be sparse.

In some examples, the module 330 may include various steps. For example, the module 330 (e.g., an encoder module) may, at 340, receive an input (e.g., z_{(i,j)}^{m,k,τ}∀{i, j, k, m}) including a first set of values of a latent variable, the channel estimations, and the gradients 380; at 345, perform a fusion of the inputs, as described herein with reference to FIG. 4; at 350, perform various attention calculations (e.g., an intra-PRG calculation at 350-a, an inter-PRG calculation at 350-b, and a cross-MIMO calculation at 350-c), as described herein with reference to FIG. 5; at 355, perform a multi-layer perceptron (e.g., MLP) procedure; and at 360, output a second set of values of the latent variable (e.g., z_{(i,j)}^{m,k,τ+1} ∀{i, j, k, m}). In some cases, the output of each step may be concatenated with the output of the next step. The module 330 may generate, via the various steps, the second set of values of the latent variable according Equation 4:

z^{τ+1}=z^{τ}+Encoder_{ϕ}_{_{τ}}(z^{τ},H^{τ},∇_{y|H}_{_{,x}}_{^{t}}) Equation 4:

In some cases, the module 335 may receive the second set of values of the latent variable and modify the channel estimations associated with the multiple layers based on the second set of values of the latent variable, the channel estimations (e.g., the channel estimations of the previous iteration) and the respective gradients. For example, the channel estimations for this iteration 310 may be generated according to the Equation 5:

H^{τ+1}=Decoder_{ψ}_{_{τ}}(z^{τ+1},H^{τ},∇_{y|H}_{_{,x}}_{^{t}}) Equation 5:

as described herein with reference to FIG. 4.

FIG. 4 illustrates an example of a network 400 that supports recurrent equivariant inference machines for channel estimation in accordance with one or more aspects of the present disclosure. In some examples, the network 400 may be implemented by aspects of the wireless communications system 100, the network 300, or both. For example, the network 400 may be implemented by a UE 115, a network entity 105, the encoder 330, the decoder 335, or any combination thereof, as described herein with reference to FIGS. 1 and 3.

In some cases, the network 400 may perform a fusion associated with neural networks. For example, the network 400 may be an example of a convolutional neural network (CNN) (e.g., a neural network that uses convolution in place of a more general matrix multiplication for multiple layers). In some cases, fusion associated with a CNN may fuse (e.g., combine, compress) two or more convolutional layers (e.g., weights associated with each layer) together.

In some examples, one or more modules (e.g., module 330, module 335) of a refinement network (e.g., refinement network 305), as described herein with reference to FIG. 3, may utilize the network 400. For example, an encoder module (e.g., module 330) may perform a fusion operation (e.g., at 345). The encoder module may generate a second set of values of a latent variable associated with multiple channel estimations based on combining (e.g., fusing) the channel estimations, respective gradients (e.g., gradients 380), and respective values of a first set of values of the latent variable. For example, the encoder module may generate output 430 (e.g., z_{(i,j)}^{m,τ+1}) based on Equation 6:

z_{(i,j)}^{m,τ+1}=FuCNN(z_{(i,j)}^{m,τ},h_{(i,j)}^{m,τ},∇_{y}_{_{f,t}}_{^{m}}_{|H}_{_{f,t}}_{^{m,τ}}_{,x}_{_{f,t}}_{^{m}}) Equation 6:

where FuCNN is the fusion operation, z_{(i,j)}^{m,τ} represents the first set of values of the latent variable (e.g., a first portion of estimate 405), h_{(i,j)}^{m,τ} represents the channel estimations (e.g., a second portion of estimate 405), and ∇_{y}_{_{f,t}}_{^{m}}_{|H}_{_{f,t}}_{^{m,τ}}_{,x}_{_{f,t}}_{^{m}} represents the respective gradients (e.g., gradient 410). For example, the encoder module may fuse the gradient 410 (e.g., from the likelihood module 325) into the hidden state variable (e.g., the first set of values of the latent variable), thus modeling MIMO multiplexing (e.g., multiplexing MIMO phenomena). The fusing operation may act independently on each PRG (e.g., PRG 205) of the channel, and incorporate the gradient 410 (e.g., gradient information) into the latent state (e.g., performing a fusion operation for each PRG of each antenna pair).

In some cases, the fusion operation may comprise various steps. For example, the encoder module may receive as input the estimates 405 (e.g., the channel estimations and the latent variable values of a previous iteration 310) and the gradients 410 (e.g., gradients 380 of a same iteration 310), as described herein with reference to FIG. 3. The encoder module may combine (e.g., fuse, concatenate) the estimates 405 and the gradients 410 to generate combination 420 (e.g., z_{(i,j)}^{m,τ}, h_{(i,j)}^{m,τ}, ∇_{y}_{_{f,t}}_{^{m}}_{|H}_{_{f,t}}_{^{m,τ}}_{,x}_{_{f,t}}_{^{m}}). In some cases, the combination 420 may be input to a u-net 425 (e.g., a tiny u-net). In some examples, the u-net 425 may be an example of a type of CNN that utilizes upsampling operators (e.g., upsampling operators with a relatively large quantity of feature channels). The u-net 425 may perform various calculations (e.g., combinations, operations) associated with a neural network to generate the output 430 (e.g., z_{(i,j)}^{m,τ+1}).

In some examples, a decoder module (e.g., module 335) may perform a fusion operation. The decoder module may modify the channel estimations (e.g., generate a second iteration of channel estimations) based on combining (e.g., fusing) the second set of values of the latent variable (e.g., output from step 360), the channel estimations, and respective gradients (e.g., gradients 380). For example, the decoder module may generate output 430 (e.g., h_{(i,j)}^{m,τ+1}) based on Equation 7:

H_{(i,j)}^{m,τ+1}=FuCNN(z_{(i,j)}^{m,τ+1},H_{(i,j)}^{m,τ},∇_{y}_{_{f,t}}_{^{m}}_{|H}_{_{f,t}}_{^{m,τ}}_{,x}_{_{f,t}}_{^{m}}) Equation 7:

where FuCNN is the fusion operation, z_{(i,j)}^{m,τ+1} represents the second set of values of the latent variable (e.g., a first portion of estimate 405), H_{(i,j)}^{m,τ} represents the channel estimations (e.g., a second portion of estimate 405), and ∇_{y}_{_{f,t}}_{^{m}}_{|H}_{_{f,t}}_{^{m,τ}}_{,x}_{_{f,t}}_{^{m}} represents the respective gradients (e.g., gradient 410). For example, the decoder module may receive as input the estimates 405 (e.g., the channel estimations and the latent variable values of a same iteration 310) and the gradients 410 (e.g., gradients 380 of the same iteration 310), as described herein with reference to FIG. 3. The decoder module may combine (e.g., fuse, concatenate) the estimates 405 and the gradients 410 to generate combination 420 (e.g., z_{(i,j)}^{m,τ+1}, h_{(i,j)}^{m,τ}, ∇_{y}_{_{f,t}}_{^{m}}_{|H}_{_{f,t}}_{^{m,τ}}_{,x}_{_{f,t}}_{^{m}}). In some cases, the combination 420 may be input to the u-net 425 (e.g., a tiny u-net). The u-net 425 may perform various calculations (e.g., combinations, operations) associated with a neural network to generate the output 430 (e.g., h_{(i,j)}^{m,τ+1}). The decoder module may utilize information from the likelihood module and the various sub-modules (steps 340 through 360) of the encoder module to update the latent variable, the channel estimates, or both. The decoder module may act independently on each PRG, utilizing the updated latent variable (e.g., the second set of values) along with the gradient information to improve the channel estimation (e.g., bring the channel estimation closer to the actual channel).

FIG. 5 illustrates an example of a network 500 that supports recurrent equivariant inference machines for channel estimation in accordance with one or more aspects of the present disclosure. In some examples, the network 500 may be implemented by aspects of the wireless communications system 100, the network 300, or both. For example, the network 500 may be implemented by a UE 115, a network entity 105, the encoder 330, or any combination thereof, as described herein with reference to FIGS. 1 and 3.

In some cases, the network 500 may perform an attention operation (e.g., attention 505) associated with neural networks. For example, the attention 505 may include weighting portions of the input data (e.g., input 510) differently than other portions of the input data (e.g., enhancing portions of the data while diminishing other portions of the data). In some cases, applying the attention 505 may focus (e.g., modify, align) the input data (e.g., the observed DMRS symbols) with the known data (e.g., the known DMRS symbols). In some examples, the attention 505 may model interaction (e.g., correlation) within the data elements 520. For example, a data element 520-a, a data element 520-b, a data element 520-c, and a data element 520-d may interact with a data element 520-e, a data element 520-f, a data element 520-g, and a data element 520-h, and vice versa.

In some cases, an encoder module (e.g., module 330) may perform the attention 505 (e.g., a self-attention), for example, at various steps (e.g., steps 350) of a channel estimation process, as described herein with reference to FIG. 3. For example, the encoder module may (e.g., at 350-a) perform an intra-PRG attention operation to model correlation between resources (e.g., resource elements) of each PRB (e.g., PRB 210) of a PRG (e.g., PRG 205) and the other PRBs of the PRG (e.g., PRBs belonging to a single PRG bundle). The encoder module may determine a set of values of a latent variable (e.g., output 430) from a fusion operation, as described herein with reference to FIG. 4. The encoder module may flatten each subset of values associated with each PRB of the PRG. For example, the set of values (e.g., z_{(i,j)}^{m,τ+1}) may include four subsets of values (e.g., z_{i,j}^{m,1}, z_{i,j}^{m,2}, z_{i,j}^{m,3}, z_{i,j}^{m,4}). The encoder module may flatten (e.g., combine, compress to a single frequency row) the four subsets into the data element 520-a, the data element 520-b, the data element 520-c, and the data element 520-d (e.g., input 510). In some cases, the data element 520-e, the data element 520-f, the data element 520-g, and the data element 520-h may be duplicates (e.g., copies) of the data element 520-a, the data element 520-b, the data element 520-c, and the data element 520-d, respectively (e.g., z_{i,j}^{m,1}, z_{i,j}^{m,2}, z_{i,j}^{m,3}, z_{i,j}^{m,4}). In some examples, the intra-PRG attention may be utilized for modeling long range correlations (e.g., PRBs separated across the frequency axis).

In some cases, the encoder module may (e.g., at 350-b) perform an inter-PRG attention operation to model correlation between resources (e.g., resource elements) of each PRG (e.g., PRG 205) of a MIMO communication. The encoder module may determine the flattened subset of values associated with each PRB of each PRG (e.g., z_{(i,j)}^{1,{k},τ+1}, z_{(i,j)}^{2,{k},τ+1}, z_{(i,j)}^{3,{k},τ+1}, z_{(i,j)}^{4,{k},τ+1}) and combine (e.g., concatenate, average, mean pulling) the flattened subsets (e.g., embedded subsets) into a single set of values (e.g., \hat{z}_{(i,j)}^{1,{k},τ+1}, \hat{z}_{(i,j)}^{2,{k},τ+1}, \hat{z}_{(i,j)}^{3,{k},τ+1}, \hat{z}_{(i,j)}^{4,{k},τ+1}) as the data element 520-a, the data element 520-b, the data element 520-c, and the data element 520-d (e.g., input 510), respectively. In some cases, the data element 520-e, the data element 520-f, the data element 520-g, and the data element 520-h may be represented by z_{i,j}^{1,τ+1}, z_{i,j}^{2,τ+1}, z_{i,j}^{3,τ+1}, z_{i,j}^{4,τ+1}, respectively. The encoder module may combine (e.g., add) the respective outputs (e.g., output 515, residual) of the attention 505 with the flattened subsets of values (e.g., e.g., z_{(i,j)}^{1,{k},τ+1}, z_{(i,j)}^{2,{k},τ+1}, z_{(i,j)}^{3,{k},τ+1}, z_{(i,j)}^{4,{k},τ+1}, the subsets before averaging) as output 515 for the inter-PRG attention. of the In some examples, the inter-PRG attention may facilitate information exchange across different PRG bundles.

In some cases, the encoder module may (e.g., at 350-c) perform a cross-MIMO attention operation to model correlation between each layer of multiple layers associated with the MIMO communication (e.g., interaction between antenna pairs per PRG bundle per PRB). In some cases, the MIMO communication may be the set of resources including the DMRS symbols 220 and the data symbols 215, as described herein with reference to FIG. 2. The encoder module may determine a source block (e.g., z_{{(i,j)}}^{m,k,τ+1}) per MIMO layer (e.g., per antenna pair). For example, in a two dimensional grid, the data element 520-a, the data element 520-b, the data element 520-c, and the data element 520-d (e.g., input 510 for the cross-MIMO attention operation) may be represented by \hat{z}_{1,1}^{m,k,τ+1}, \hat{z}_{1,2}^{m,k,τ+1}, \hat{z}_{2,1}^{m,k,τ+1}, \hat{z}_{2,2}^{m,k,τ+1}, respectively. In some cases, the data element 520-e, the data element 520-f, the data element 520-g, and the data element 520-h may be represented by z_{1,1}^{m,k,τ+1}, z_{1,2}^{m,k,τ+1}, z_{2,2}^{m,k,τ+1}, and z_{2,2}^{m,k,τ+1}, respectively. The encoder module may output 515 for the cross-MIMO attention. of the In some examples, the cross-MIMO attention may model interaction (e.g., correlation) between different transmission links per PRG per PRB (e.g., between different MIMO links in an equivariant way).

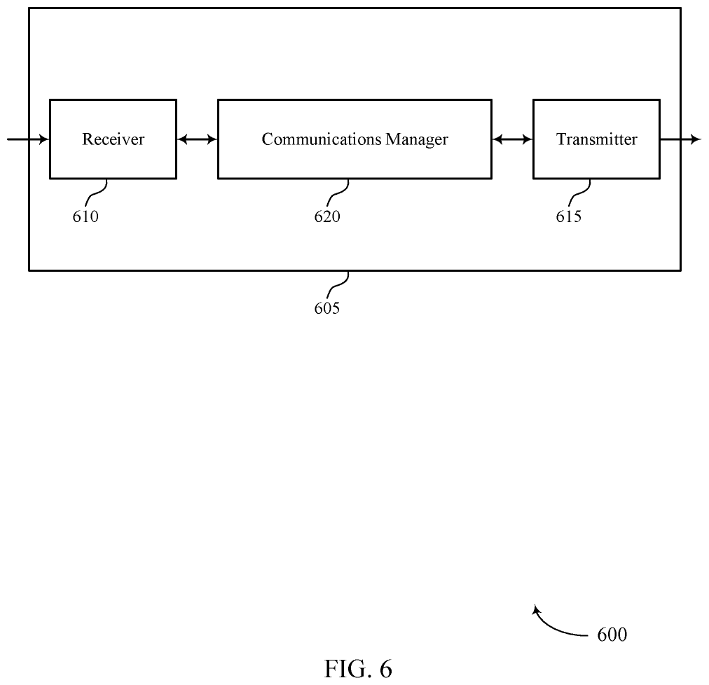

FIG. 6 shows a block diagram 600 of a device 605 that supports recurrent equivariant inference machines for channel estimation in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to recurrent equivariant inference machines for channel estimation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to recurrent equivariant inference machines for channel estimation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of recurrent equivariant inference machines for channel estimation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 may be configured as or otherwise support a means for receiving an assignment of a set of resources associated with a channel including a first subset of resources allocated for a data signal and a second subset of resources allocated for a reference signal. The communications manager 620 may be configured as or otherwise support a means for generating a set of multiple channel estimations associated with respective layers of a set of multiple layers of the channel for the set of resources. The communications manager 620 may be configured as or otherwise support a means for performing a refinement operation on the set of multiple channel estimations including one or more iterations. In some examples, to each iteration of the one or more iterations, the communications manager 620 may be configured as or otherwise support a means for generating respective gradients associated with the set of multiple channel estimations based on the set of multiple channel estimations for the second subset of resources and measured observations of the second subset of resources, generating, based on a first set of values of a latent variable, the set of multiple channel estimations, and the respective gradients, a second set of values of the latent variable, and modifying the set of multiple channel estimations associated with the set of multiple layers based on the second set of values of the latent variable, the set of multiple channel estimations, and the respective gradients.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more accurate channel estimations, more efficient utilization of communication resources, and decreased memory and computational overhead.

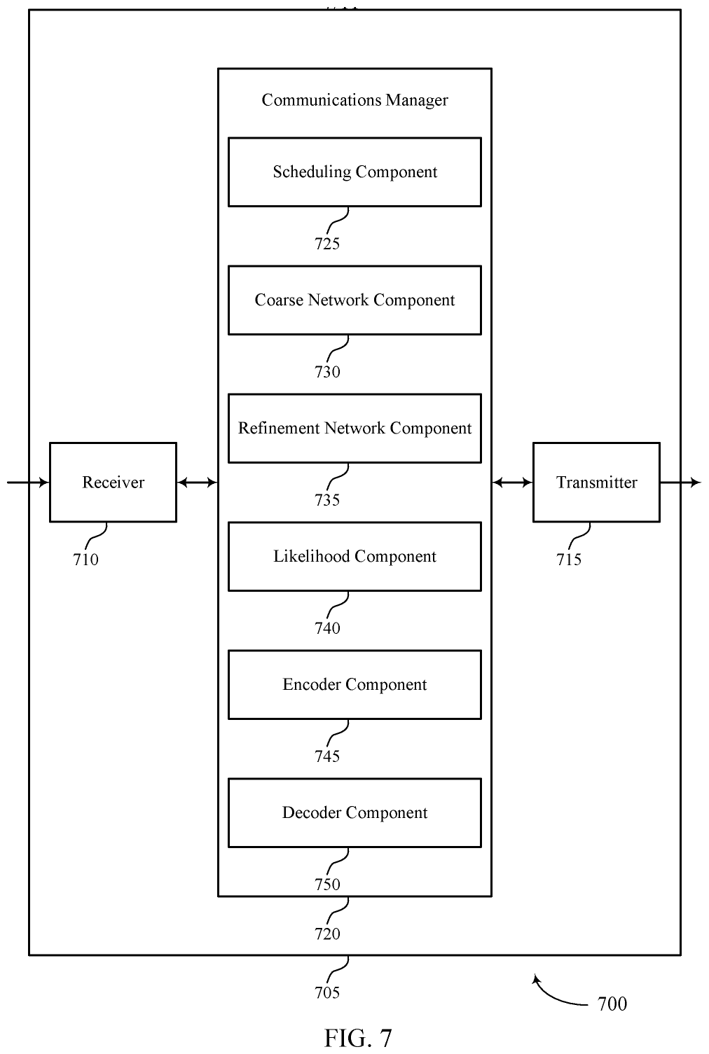

FIG. 7 shows a block diagram 700 of a device 705 that supports recurrent equivariant inference machines for channel estimation in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to recurrent equivariant inference machines for channel estimation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to recurrent equivariant inference machines for channel estimation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of recurrent equivariant inference machines for channel estimation as described herein. For example, the communications manager 720 may include a scheduling component 725, a coarse network component 730, a refinement network component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The scheduling component 725 may be configured as or otherwise support a means for receiving an assignment of a set of resources associated with a channel including a first subset of resources allocated for a data signal and a second subset of resources allocated for a reference signal. The coarse network component 730 may be configured as or otherwise support a means for generating a set of multiple channel estimations associated with respective layers of a set of multiple layers of the channel for the set of resources. The refinement network component 735 may be configured as or otherwise support a means for performing a refinement operation on the set of multiple channel estimations including one or more iterations. In some examples, to each iteration of the one or more iterations, the likelihood component 740 may be configured as or otherwise support a means for generating respective gradients associated with the set of multiple channel estimations based on the set of multiple channel estimations for the second subset of resources and measured observations of the second subset of resources, the encoder component 745 may be configured as or otherwise support a means for generating, based on a first set of values of a latent variable, the set of multiple channel estimations, and the respective gradients, a second set of values of the latent variable, and the decoder component 750 may be configured as or otherwise support a means for modifying the set of multiple channel estimations associated with the set of multiple layers based on the second set of values of the latent variable, the set of multiple channel estimations, and the respective gradients.

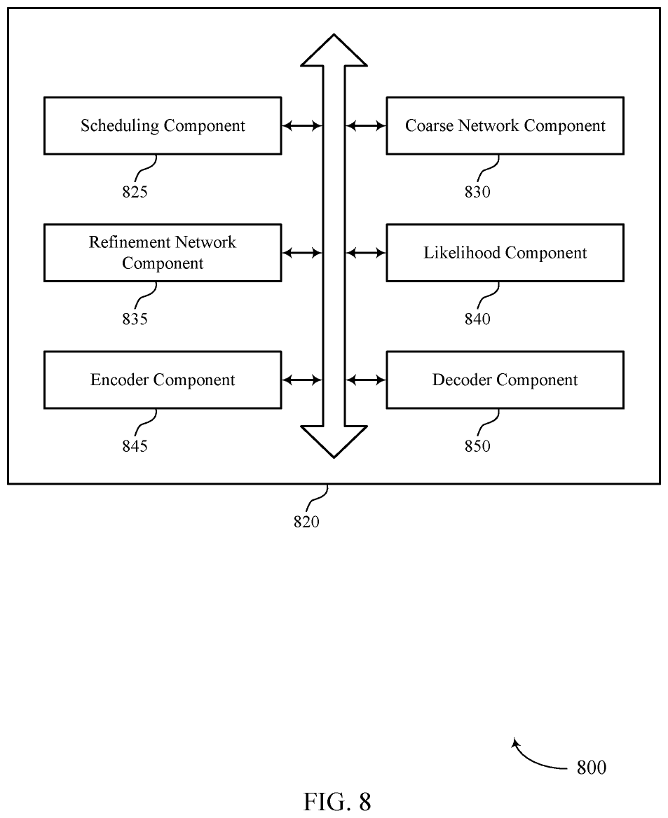

FIG. 8 shows a block diagram 800 of a communications manager 820 that supports recurrent equivariant inference machines for channel estimation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of recurrent equivariant inference machines for channel estimation as described herein. For example, the communications manager 820 may include a scheduling component 825, a coarse network component 830, a refinement network component 835, a likelihood component 840, an encoder component 845, a decoder component 850, or any combination thereof. Each of these components may communicate, directly or indirectly, with one another (e.g., via one or more buses).

The communications manager 820 may support wireless communication in accordance with examples as disclosed herein. The scheduling component 825 may be configured as or otherwise support a means for receiving an assignment of a set of resources associated with a channel including a first subset of resources allocated for a data signal and a second subset of resources allocated for a reference signal. The coarse network component 830 may be configured as or otherwise support a means for generating a set of multiple channel estimations associated with respective layers of a set of multiple layers of the channel for the set of resources. The refinement network component 835 may be configured as or otherwise support a means for performing a refinement operation on the set of multiple channel estimations including one or more iterations. In some examples, to each iteration of the one or more iterations, the likelihood component 840 may be configured as or otherwise support a means for generating respective gradients associated with the set of multiple channel estimations based on the set of multiple channel estimations for the second subset of resources and measured observations of the second subset of resources, the encoder component 845 may be configured as or otherwise support a means for generating, based on a first set of values of a latent variable, the set of multiple channel estimations, and the respective gradients, a second set of values of the latent variable, and the decoder component 850 may be configured as or otherwise support a means for modifying the set of multiple channel estimations associated with the set of multiple layers based on the second set of values of the latent variable, the set of multiple channel estimations, and the respective gradients.

In some examples, to support generating the respective gradients, the likelihood component 840 may be configured as or otherwise support a means for generating respective sets of values of a residual variable based on a difference between the measured observations of the second subset of resources and the set of multiple channel estimations for the second subset of resources. In some examples, to support generating the respective gradients, the likelihood component 840 may be configured as or otherwise support a means for combining the respective sets of values of the residual variable, the measured observations of the second subset of resources, and a quantity of mask bits.

In some examples, to support generating the second set of values of the latent variable, the encoder component 845 may be configured as or otherwise support a means for combining the set of multiple channel estimations for the second subset of resources, the respective gradients, and respective values of the first set of values of the latent variable based on generating the respective gradients.

In some examples, to support generating the second set of values of the latent variable, the encoder component 845 may be configured as or otherwise support a means for modeling correlation between resources of each resource block of a group of resource blocks and other resource blocks of the group of resource blocks.

In some examples, to support generating the second set of values of the latent variable, the encoder component 845 may be configured as or otherwise support a means for modeling correlation between resources of each group of a set of multiple groups of resources of the set of resources and other groups of the set of multiple groups of resources, where each group of the set of multiple groups of resources includes a set of multiple resource blocks.

In some examples, to support generating the second set of values of the latent variable, the encoder component 845 may be configured as or otherwise support a means for modeling correlation between each layer of the set of multiple layers for the set of resources.

In some examples, to support modifying the set of multiple channel estimations, the decoder component 850 may be configured as or otherwise support a means for combining the second set of values of the latent variable, the set of multiple channel estimations, and the respective gradients.

In some examples, initial values of the set of multiple channel estimations are associated with SISO antenna pairs.

In some examples, the second subset of resources are configured according to a resource configuration pattern of a set of resource configuration patterns.

In some examples, the set of resource configuration patterns is a set of DMRS patterns.

In some examples, each iteration is performed by a refinement network including a likelihood module, an encoder module, and a decoder module, and each refinement network further includes a respective parameter associated with a machine learning operation.

In some examples, the set of resources includes one or more groups of resources, and each respective layer of the set of multiple layers is associated with a respective antenna pair of a set of multiple SISO antenna pairs.

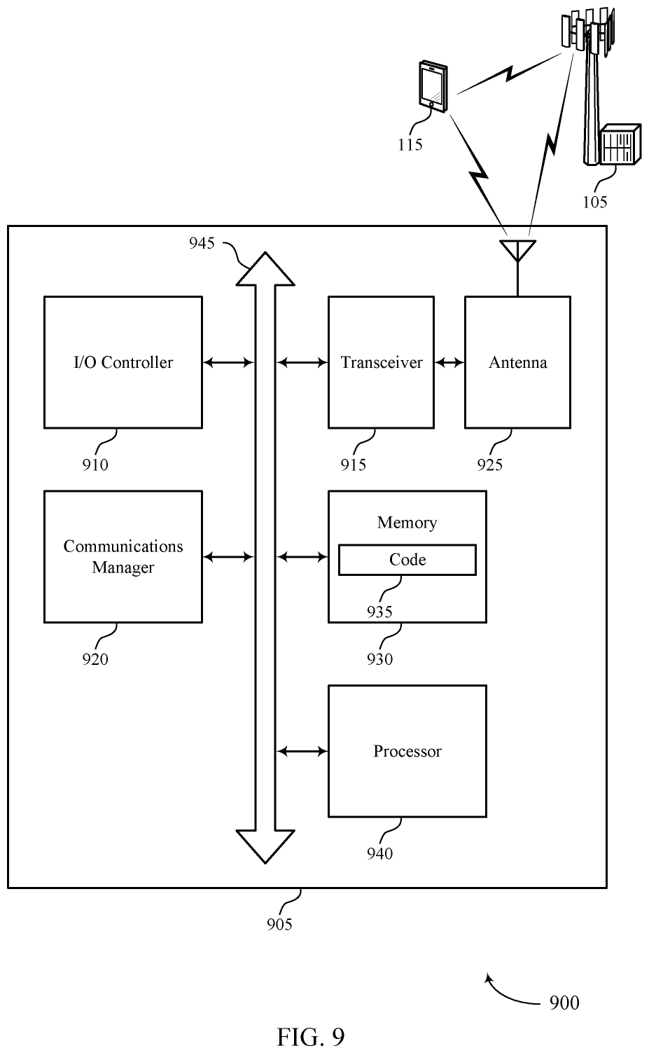

FIG. 9 shows a diagram of a system 900 including a device 905 that supports recurrent equivariant inference machines for channel estimation in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting recurrent equivariant inference machines for channel estimation). For example, the device 905 or a component of the device 905 may include a processor 940 and memory 930 coupled with or to the processor 940, the processor 940 and memory 930 configured to perform various functions described herein.

The communications manager 920 may support wireless communication in accordance with examples as disclosed herein. For example, the communications manager 920 may be configured as or otherwise support a means for receiving an assignment of a set of resources associated with a channel including a first subset of resources allocated for a data signal and a second subset of resources allocated for a reference signal. The communications manager 920 may be configured as or otherwise support a means for generating a set of multiple channel estimations associated with respective layers of a set of multiple layers of the channel for the set of resources. The communications manager 920 may be configured as or otherwise support a means for performing a refinement operation on the set of multiple channel estimations including one or more iterations. In some examples, to each iteration of the one or more iterations, the communications manager 920 may be configured as or otherwise support a means for generating respective gradients associated with the set of multiple channel estimations based on the set of multiple channel estimations for the second subset of resources and measured observations of the second subset of resources, generating, based on a first set of values of a latent variable, the set of multiple channel estimations, and the respective gradients, a second set of values of the latent variable, and modifying the set of multiple channel estimations associated with the set of multiple layers based on the second set of values of the latent variable, the set of multiple channel estimations, and the respective gradients.

By including or configuring the communications manager 920 in accordance with examples as described herein, the device 905 may support techniques for improved communication reliability, reduced latency, improved user experience related to reduced processing, reduced power consumption, more efficient utilization of communication resources, more accurate channel estimations, and decreased memory and computational overhead.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of recurrent equivariant inference machines for channel estimation as described herein, or the processor 940 and the memory 930 may be otherwise configured to perform or support such operations.

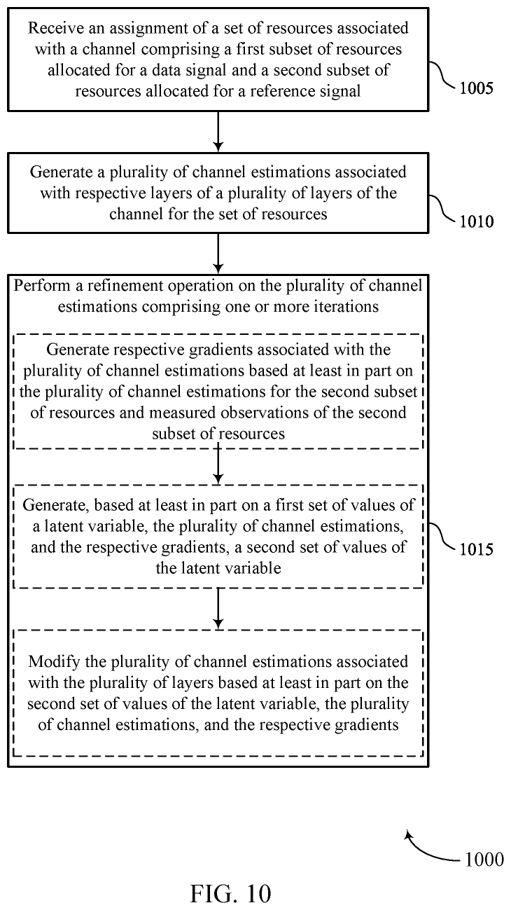

FIG. 10 shows a flowchart illustrating a method 1000 that supports recurrent equivariant inference machines for channel estimation in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving an assignment of a set of resources associated with a channel including a first subset of resources allocated for a data signal and a second subset of resources allocated for a reference signal. Receiving the assignment may include identifying time-frequency resources over which the assignment is transmitted, demodulating transmission over those time-frequency resources, decoding the demodulated transmission to obtain bits that indicate the assignment. The assignment may be received via DCI in a downlink control channel. The operations of 1005 may be performed in accordance with examples as disclosed herein. In some examples, aspects of the operations of 1005 may be performed by a scheduling component 825 as described with reference to FIG. 8.

At 1010, the method may include generating a set of multiple channel estimations associated with respective layers of a set of multiple layers of the channel for the set of resources. Generating the set of multiple channel estimations may include performing various interpolation techniques, as described herein with reference to FIG. 2, to calculate an estimation per PRG per antenna pair (e.g., a SISO channel estimation). The operations of 1010 may be performed in accordance with examples as disclosed herein. In some examples, aspects of the operations of 1010 may be performed by a coarse network component 830 as described with reference to FIG. 8.

At 1015, the method may include performing a refinement operation on the set of multiple channel estimations including one or more iterations. Performing the refinement operation may include calculating (e.g., updating, generating), via a refinement network as described herein with reference to FIGS. 3-5, various channel estimations (e.g., MIMO channel estimation) and refining the estimations over various iterations of a machine learning operation. In some examples, each iteration of the one or more iterations may include generating respective gradients associated with the set of multiple channel estimations based on the set of multiple channel estimations for the second subset of resources and measured observations of the second subset of resources, generating, based on a first set of values of a latent variable, the set of multiple channel estimations, and the respective gradients, a second set of values of the latent variable, and modifying the set of multiple channel estimations associated with the set of multiple layers based on the second set of values of the latent variable, the set of multiple channel estimations, and the respective gradients. The operations of 1015 may be performed in accordance with examples as disclosed herein. In some examples, aspects of the operations of 1015 may be performed by a refinement network component 835 as described with reference to FIG. 8.

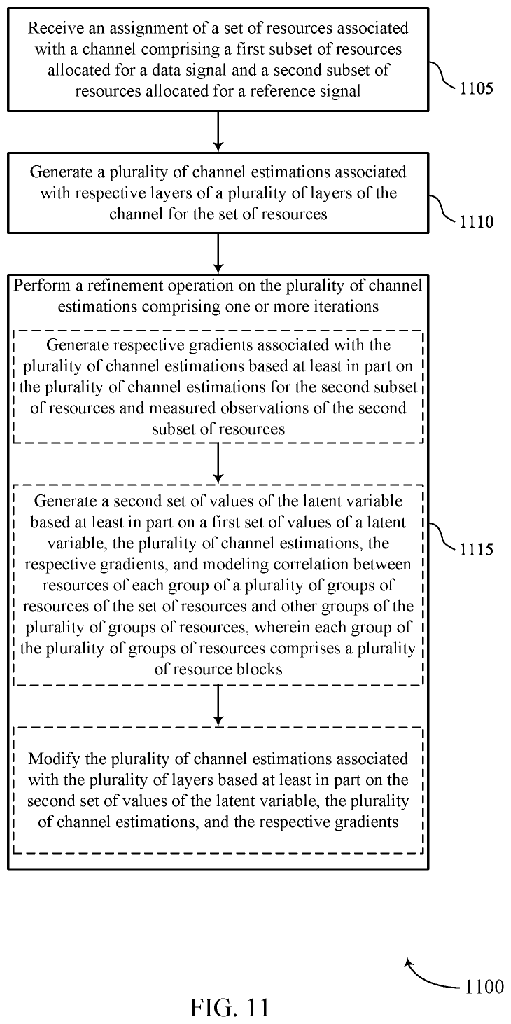

FIG. 11 shows a flowchart illustrating a method 1100 that supports recurrent equivariant inference machines for channel estimation in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving an assignment of a set of resources associated with a channel including a first subset of resources allocated for a data signal and a second subset of resources allocated for a reference signal. Receiving the assignment may include identifying time-frequency resources over which the assignment is transmitted, demodulating transmission over those time-frequency resources, decoding the demodulated transmission to obtain bits that indicate the assignment. The assignment may be received via DCI in a downlink control channel. The operations of 1105 may be performed in accordance with examples as disclosed herein. In some examples, aspects of the operations of 1105 may be performed by a scheduling component 825 as described with reference to FIG. 8.

At 1110, the method may include generating a set of multiple channel estimations associated with respective layers of a set of multiple layers of the channel for the set of resources. Generating the set of multiple channel estimations may include performing various interpolation techniques, as described herein with reference to FIG. 2, to calculate an estimation per PRG per antenna pair (e.g., a SISO channel estimation). The operations of 1110 may be performed in accordance with examples as disclosed herein. In some examples, aspects of the operations of 1110 may be performed by a coarse network component 830 as described with reference to FIG. 8.

At 1115, the method may include performing a refinement operation on the set of multiple channel estimations including one or more iterations. Performing the refinement operation may include calculating (e.g., updating, generating), via a refinement network as described herein with reference to FIGS. 3-5, various channel estimations (e.g., MIMO channel estimation) and refining the estimations over various iterations of a machine learning operation. In some examples, each iteration of the one or more iterations may include generating respective gradients associated with the set of multiple channel estimations based on the set of multiple channel estimations for the second subset of resources and measured observations of the second subset of resources, generating a second set of values of a latent variable (e.g., z^{τ}) based at least in part on a first set of values of the latent variable, the plurality of channel estimations, the respective gradients, and modeling correlation between resources of each group of a plurality of groups of resources of the set of resources and other groups of the plurality of groups of resources, wherein each group of the plurality of groups of resources comprises a plurality of resource blocks, and modifying the set of multiple channel estimations associated with the set of multiple layers based on the second set of values of the latent variable, the set of multiple channel estimations, and the respective gradients. The operations of 1115 may be performed in accordance with examples as disclosed herein. In some examples, aspects of the operations of 1115 may be performed by a likelihood module (e.g., module 325), an encoder module (e.g., module 330), or a decoder module (e.g., module 335). In some examples, aspects of the operations of 1115 may be performed by a refinement network component 835 as described with reference to FIG. 8.

The following provides an overview of aspects of the present disclosure:

Aspect 1: A method for wireless communication, comprising: receiving an assignment of a set of resources associated with a channel comprising a first subset of resources allocated for a data signal and a second subset of resources allocated for a reference signal; generating a plurality of channel estimations associated with respective layers of a plurality of layers of the channel for the set of resources; and performing a refinement operation on the plurality of channel estimations comprising one or more iterations, wherein each iteration of the one or more iterations comprises: generating respective gradients associated with the plurality of channel estimations based at least in part on the plurality of channel estimations for the second subset of resources and measured observations of the second subset of resources; generating, based at least in part on a first set of values of a latent variable, the plurality of channel estimations, and the respective gradients, a second set of values of the latent variable; and modifying the plurality of channel estimations associated with the plurality of layers based at least in part on the second set of values of the latent variable, the plurality of channel estimations, and the respective gradients.

Aspect 2: The method of aspect 1, wherein generating the respective gradients comprises: generating respective sets of values of a residual variable based at least in part on a difference between the measured observations of the second subset of resources and the plurality of channel estimations for the second subset of resources; and combining the respective sets of values of the residual variable, the measured observations of the second subset of resources, and a quantity of mask bits.

Aspect 3: The method of any of aspects 1 through 2, wherein generating the second set of values of the latent variable comprises: combining the plurality of channel estimations for the second subset of resources, the respective gradients, and respective values of the first set of values of the latent variable based at least in part on generating the respective gradients.

Aspect 4: The method of any of aspects 1 through 3, wherein generating the second set of values of the latent variable comprises: modeling correlation between resources of each resource block of a group of resource blocks and other resource blocks of the group of resource blocks.

Aspect 5: The method of any of aspects 1 through 4, wherein generating the second set of values of the latent variable comprises: modeling correlation between resources of each group of a plurality of groups of resources of the set of resources and other groups of the plurality of groups of resources, wherein each group of the plurality of groups of resources comprises a plurality of resource blocks.

Aspect 6: The method of any of aspects 1 through 5, wherein generating the second set of values of the latent variable comprises: modeling correlation between each layer of the plurality of layers for the set of resources.

Aspect 7: The method of any of aspects 1 through 6, wherein modifying the plurality of channel estimations comprises: combining the second set of values of the latent variable, the plurality of channel estimations, and the respective gradients.

Aspect 8: The method of any of aspects 1 through 7, wherein initial values of the plurality of channel estimations are associated with SISO antenna pairs.

Aspect 9: The method of any of aspects 1 through 8, wherein the second subset of resources are configured according to a resource configuration pattern of a set of resource configuration patterns.

Aspect 10: The method of aspect 9, wherein the set of resource configuration patterns is a set of DMRS patterns.

Aspect 11: The method of any of aspects 1 through 10, wherein each iteration is performed by a refinement network comprising a likelihood module, an encoder module, and a decoder module, and each refinement network further comprises a respective parameter associated with a machine learning operation.

Aspect 12: The method of any of aspects 1 through 11, wherein the set of resources comprises one or more groups of resources, and each respective layer of the plurality of layers is associated with a respective antenna pair of a plurality of SISO antenna pairs.

Aspect 13: An apparatus for wireless communication, comprising a processor; memory coupled with the processor; and instructions stored in the memory and executable by the processor to cause the apparatus to perform a method of any of aspects 1 through 12.

Aspect 14: An apparatus for wireless communication, comprising at least one means for performing a method of any of aspects 1 through 12.

Aspect 15: A non-transitory computer-readable medium storing code for wireless communication, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
receive an assignment of a set of resources associated with a channel comprising a first subset of resources allocated for a data signal and a second subset of resources allocated for a reference signal;
generate a plurality of channel estimations associated with respective layers of a plurality of layers of the channel for the set of resources; and
perform a refinement operation on the plurality of channel estimations comprising one or more iterations, wherein the instructions to each iteration of the one or more iterations are executable by the processor to cause the apparatus to:
generate respective gradients associated with the plurality of channel estimations based at least in part on the plurality of channel estimations for the second subset of resources and measured observations of the second subset of resources;
generate, based at least in part on a first set of values of a latent variable, the plurality of channel estimations, and the respective gradients, a second set of values of the latent variable; and
modify the plurality of channel estimations associated with the plurality of layers based at least in part on the second set of values of the latent variable, the plurality of channel estimations, and the respective gradients.

2. The apparatus of claim 1, wherein the instructions to generate the respective gradients are executable by the processor to cause the apparatus to:
generate respective sets of values of a residual variable based at least in part on a difference between the measured observations of the second subset of resources and the plurality of channel estimations for the second subset of resources; and
combine the respective sets of values of the residual variable, the measured observations of the second subset of resources, and a quantity of mask bits.

3. The apparatus of claim 1, wherein the instructions to generate the second set of values of the latent variable are executable by the processor to cause the apparatus to:
combine the plurality of channel estimations for the second subset of resources, the respective gradients, and respective values of the first set of values of the latent variable based at least in part on generating the respective gradients.

4. The apparatus of claim 1, wherein the instructions to generate the second set of values of the latent variable are executable by the processor to cause the apparatus to:
model correlation between resources of each resource block of a group of resource blocks and other resource blocks of the group of resource blocks.

5. The apparatus of claim 1, wherein the instructions to generate the second set of values of the latent variable are executable by the processor to cause the apparatus to:
model correlation between resources of each group of a plurality of groups of resources of the set of resources and other groups of the plurality of groups of resources, wherein each group of the plurality of groups of resources comprises a plurality of resource blocks.

6. The apparatus of claim 1, wherein the instructions to generate the second set of values of the latent variable are executable by the processor to cause the apparatus to:
model correlation between each layer of the plurality of layers for the set of resources.

7. The apparatus of claim 1, wherein the instructions to modify the plurality of channel estimations are executable by the processor to cause the apparatus to:
combine the second set of values of the latent variable, the plurality of channel estimations, and the respective gradients.

8. The apparatus of claim 1, wherein:
initial values of the plurality of channel estimations are associated with single-input and single-output antenna pairs.

9. The apparatus of claim 1, wherein the second subset of resources are configured according to a resource configuration pattern of a set of resource configuration patterns.

10. The apparatus of claim 9, wherein the set of resource configuration patterns is a set of demodulation reference signal patterns.

11. The apparatus of claim 1, wherein each iteration is performed by a refinement network comprising a likelihood module, an encoder module, and a decoder module, and each refinement network further comprises a respective parameter associated with a machine learning operation.

12. The apparatus of claim 1, wherein the set of resources comprises one or more groups of resources, and each respective layer of the plurality of layers is associated with a respective antenna pair of a plurality of single-input and single-output antenna pairs.

13. A method for wireless communication, comprising:
receiving an assignment of a set of resources associated with a channel comprising a first subset of resources allocated for a data signal and a second subset of resources allocated for a reference signal;
generating a plurality of channel estimations associated with respective layers of a plurality of layers of the channel for the set of resources; and
performing a refinement operation on the plurality of channel estimations comprising one or more iterations, wherein each iteration of the one or more iterations comprises:
generating respective gradients associated with the plurality of channel estimations based at least in part on the plurality of channel estimations for the second subset of resources and measured observations of the second subset of resources;
generating, based at least in part on a first set of values of a latent variable, the plurality of channel estimations, and the respective gradients, a second set of values of the latent variable; and
modifying the plurality of channel estimations associated with the plurality of layers based at least in part on the second set of values of the latent variable, the plurality of channel estimations, and the respective gradients.

14. The method of claim 13, wherein generating the respective gradients comprises:
generating respective sets of values of a residual variable based at least in part on a difference between the measured observations of the second subset of resources and the plurality of channel estimations for the second subset of resources; and
combining the respective sets of values of the residual variable, the measured observations of the second subset of resources, and a quantity of mask bits.

15. The method of claim 13, wherein generating the second set of values of the latent variable comprises:
combining the plurality of channel estimations for the second subset of resources, the respective gradients, and respective values of the first set of values of the latent variable based at least in part on generating the respective gradients.

16. The method of claim 13, wherein generating the second set of values of the latent variable comprises:
modeling correlation between resources of each resource block of a group of resource blocks and other resource blocks of the group of resource blocks.

17. The method of claim 13, wherein generating the second set of values of the latent variable comprises:
modeling correlation between resources of each group of a plurality of groups of resources of the set of resources and other groups of the plurality of groups of resources, wherein each group of the plurality of groups of resources comprises a plurality of resource blocks.

18. The method of claim 13, wherein generating the second set of values of the latent variable comprises:
modeling correlation between each layer of the plurality of layers for the set of resources.

19. The method of claim 13, wherein modifying the plurality of channel estimations comprises:
combining the second set of values of the latent variable, the plurality of channel estimations, and the respective gradients.

20. The method of claim 13, wherein initial values of the plurality of channel estimations are associated with single-input and single-output antenna pairs.

21. The method of claim 13, wherein the second subset of resources are configured according to a resource configuration pattern of a set of resource configuration patterns.

22. The method of claim 21, wherein the set of resource configuration patterns is a set of demodulation reference signal patterns.

23. The method of claim 13, wherein each iteration is performed by a refinement network comprising a likelihood module, an encoder module, and a decoder module, and each refinement network further comprises a respective parameter associated with a machine learning operation.

24. The method of claim 13, wherein the set of resources comprises one or more groups of resources, and each respective layer of the plurality of layers is associated with a respective antenna pair of a plurality of single-input and single-output antenna pairs.

25. An apparatus for wireless communication, comprising:
means for receiving an assignment of a set of resources associated with a channel comprising a first subset of resources allocated for a data signal and a second subset of resources allocated for a reference signal;
means for generating a plurality of channel estimations associated with respective layers of a plurality of layers of the channel for the set of resources; and
means for performing a refinement operation on the plurality of channel estimations comprising one or more iterations, wherein the means for each iteration of the one or more iterations comprise:
generating respective gradients associated with the plurality of channel estimations based at least in part on the plurality of channel estimations for the second subset of resources and measured observations of the second subset of resources;
generating, based at least in part on a first set of values of a latent variable, the plurality of channel estimations, and the respective gradients, a second set of values of the latent variable; and
modifying the plurality of channel estimations associated with the plurality of layers based at least in part on the second set of values of the latent variable, the plurality of channel estimations, and the respective gradients.

26. The apparatus of claim 25, wherein the means for generating the second set of values of the latent variable comprise:
means for modeling correlation between resources of each group of a plurality of groups of resources of the set of resources and other groups of the plurality of groups of resources, wherein each group of the plurality of groups of resources comprises a plurality of resource blocks.

27. The apparatus of claim 25, wherein the means for generating the second set of values of the latent variable comprise:
means for modeling correlation between each layer of the plurality of layers for the set of resources.

28. A non-transitory computer-readable medium storing code for wireless communication, the code comprising instructions executable by a processor to:
receive an assignment of a set of resources associated with a channel comprising a first subset of resources allocated for a data signal and a second subset of resources allocated for a reference signal;
generate a plurality of channel estimations associated with respective layers of a plurality of layers of the channel for the set of resources; and
perform a refinement operation on the plurality of channel estimations comprising one or more iterations, wherein the instructions to each iteration of the one or more iterations are executable to:
generate respective gradients associated with the plurality of channel estimations based at least in part on the plurality of channel estimations for the second subset of resources and measured observations of the second subset of resources;
generate, based at least in part on a first set of values of a latent variable, the plurality of channel estimations, and the respective gradients, a second set of values of the latent variable; and
modify the plurality of channel estimations associated with the plurality of layers based at least in part on the second set of values of the latent variable, the plurality of channel estimations, and the respective gradients.

29. The non-transitory computer-readable medium of claim 28, wherein the instructions to generate the second set of values of the latent variable are executable by the processor to:
model correlation between resources of each group of a plurality of groups of resources of the set of resources and other groups of the plurality of groups of resources, wherein each group of the plurality of groups of resources comprises a plurality of resource blocks.

30. The non-transitory computer-readable medium of claim 28, wherein the instructions to generate the second set of values of the latent variable are executable by the processor to:
model correlation between each layer of the plurality of layers for the set of resources.
